(19) United States
(12) Patent Application Publication
(10) Pub. No.: US 2015/0269659 A1
(43) Pub. Date: Sep. 24, 2015

(54) BALL GLOVE SELECTION SYSTEM AND METHOD

(71) Applicant: Mizuno USA, Inc., Norcross, GA (US)

(72) Inventors: Steven Mikolajczak, Norcross, GA (US); Timothy Rumer, Norcross, GA (US); Benjamin King, Norcross, GA (US); Amy Luckie, Norcross, GA (US); Laura Stando, Norcross, GA (US); Joel Thompson, Norcross, GA (US)

(21) Appl. No.: 14/662,933

(22) Filed: Mar. 19, 2015

Related U.S. Application Data
(60) Provisional application No. 61/955,277, filed on Mar. 19, 2014.

(51) Int. Cl. G06Q 30/06; G06F 3/01

(52) U.S. Cl. CPC G06Q 30/0643; G06F 3/011

(57) ABSTRACT

A system and method for providing ball glove selection is disclosed. The system for selecting an appropriate ball glove for a user can include a database that includes parameters corresponding to one or more ball glove products. The system can further include a user interface configured to collect information corresponding to the user's playing requirements. The system can include a processor that compares the information collected by the user interface with the one or more parameters in the database. As a result of this comparison, the user interface can display one or more ball glove products to the user in order of relevance, as determined by the processor.

### CROSS-REFERENCE TO RELATED APPLICATIONS AND PRIORITY CLAIM

This application is a non-provisional application which claims the benefit, under 35 U.S.C. §119(e), to U.S. Provisional Patent Application No. 61/955,277, of the same title, filed Mar. 19, 2014, the entire contents and substance of that application is incorporated herein by reference as if fully set forth below.

### BACKGROUND OF THE INVENTION

1. Field of the Invention

Embodiments of the present invention relate generally to a system and method for selecting an appropriate ball glove, and more specifically to a computer-implemented system and method for same.

2. Background of Related Art

Thousands of baseball, softball, and other types of gloves are used in a variety of sports. Baseball gloves, for example, may vary in size and materials from softball gloves due to the different size balls and different pitching speeds, for example. In addition, different gloves exist within baseball (or softball) for specific positions, playing levels, cost levels, and age groups, among other things.

The mitt used by a catcher, for example, is well padded and rounded to prevent injury to the catcher's hand during play. Similarly, since the first basemen receive repeated, often powerful, throws to first base and thus, often use a mitt similar to a catcher's mitt, though slightly smaller. Outfielders, on the other hand, typically use large basket style gloves to improve their ability to make open field catches and to enable them to remove the ball quickly from the glove.

In addition to positional differences, players of different ages also require different sizes and types of gloves. A major or minor league professional player, for example, obviously needs a larger glove and has a larger budget than a little league player. Little league players may require a softer leather to be able to close the glove, while an older player may prefer stiffer leather for improved durability.

Unfortunately, ball gloves are sometimes not very well described by the manufacturer or retailer. As a result, consumers are often at the mercy of retail employees, who may have limited knowledge themselves, or to doing their own internet research, for example. What is needed, therefore, is a system and method that enables consumers to make intelligent choices about which glove is appropriate for their specific situation. The system should take advantage of easy to use menu driven technology, yet improve consumer information and confidence. The system can be computer based and can be provided, for example and not limitation, online or at a kiosk. It is to such a system that embodiments of the present invention are primarily directed.

### BRIEF SUMMARY OF THE INVENTION

Embodiments of the present invention relate generally to a ball glove selection system, and more specifically to a computer-based glove selection system that can be provided locally, or can be available on the internet.

In some embodiments, a system for selecting an appropriate ball glove for a user, can include a database including parameters corresponding to one or more ball glove products. A system may further include a user interface configured to collect information corresponding to the user's playing requirements. In some embodiments, the system includes a processor that compares the information collected by the user interface with the one or more parameters of the database. As a result of this comparison, the user interface is configured to display one or more ball glove products to the user in an order determined by the processor.

In some embodiments, the ball glove parameters include handedness, age, position, frequency of play, and/or price. The order in which ball glove products are displayed may be, for example, in descending order of appropriateness for the user's playing requirements. The system may be accessible via an internet connected device, such as a tablet, PC, mobile phone, or laptop.

The system can be implemented, for example, as an interactive website, enabling the user to simply answer a few questions online and then providing recommendations. The system can also be implemented, for example, as a computerized kiosk located in a retail location. In this manner, the system can enable users to select an appropriate glove without having to locate a store employee, for example, who may or may not know anything about ball gloves.

Similarly, the system can be employed as a labeling system on the gloves themselves. The system can provide a key to the parameters provided on the tags. In some embodiments, the system can also enable like gloves (i.e., with like tags) to be grouped in the retail setting to ensure an improved user shopping experience.

The system can use a number of parameters including, but not limited to, a player's age, playing frequency, the type of team they play on, and which hand they catch with. Players can enter their actual (or aspiring) parameters to select an appropriate glove. In some embodiments, the system can rank gloves based on their relevance to the user's indicated preferences.

These and other objects, features and advantages of the present invention will become more apparent upon reading the following specification in conjunction with the accompanying drawing figures.

### BRIEF DESCRIPTION OF THE DRAWINGS

FIGS. 1a-1d depict a number of parameters provided in a graphical user interface for selection by a user, in accordance with some embodiments of the present invention.

FIG. 2 depicts an exemplary hang tag for the system, in accordance with some embodiments of the present invention.

FIG. 3 depicts a flowchart for the system, in accordance with some embodiments of the present invention.

### DETAILED DESCRIPTION OF THE INVENTION

Embodiments of the present invention relate generally to a ball glove selection system, and more specifically to a computer-based glove selection system that can be provided locally, or can be available on the internet, for example. The system can comprise a number of menus to guide users to the selection of an appropriate glove. The system can include variables such as, for example and not limitation, age, position, frequency of play, and level of skill The system can also include a system of tags, or labels, that provide similar information in the consumer setting (i.e., at a sporting goods store).

To simplify and clarify explanation, the system is described below as a system for selecting baseball or softball gloves. One skilled in the art will recognize, however, that the invention is not so limited. The system can also be deployed to select a number of other sporting goods products including gloves for other sports (i.e., cricket) and other types of equipment such as, for example, baseball bats, hockey sticks, or football helmets. The system can also be deployed as a labeling or tagging system, including relevant features on an easy to read tag or label on the product itself.

The materials described hereinafter as making up the various elements of the present invention are intended to be illustrative and not restrictive. Many suitable materials that would perform the same or a similar function as the materials described herein are intended to be embraced within the scope of the invention. Such other materials not described herein can include, but are not limited to, materials that are developed after the time of the development of the invention, for example. Any dimensions listed in the various drawings are for illustrative purposes only and are not intended to be limiting. Other dimensions and proportions are contemplated and intended to be included within the scope of the invention.

As mentioned above, consumers find it difficult to select an appropriate ball glove from the myriad choices on the market. A search on one major retailer's website, for example, for “baseball glove” yields over 200 results with prices ranging from $13.40 to $500.00. According to one study, 45% of consumers reported that the baseball section at most retailers is difficult to shop. In another study, 35% of consumers say that they could not find what they wanted or determine what was appropriate, and as a result, 64% of final buying decisions about gloves are made in the store.

What is needed, therefore, is a simpler and more accurate way to buy the correct glove. In one poll, 84% of parents said that dividing gloves into age groups would make it easier to select the right glove. Similarly, 72% of teens said “Team Type” (i.e., traveling, high school, minor league) would make easier to select the right glove. In light of these shortcomings, embodiments of the present invention relate to a system for selecting a ball glove.

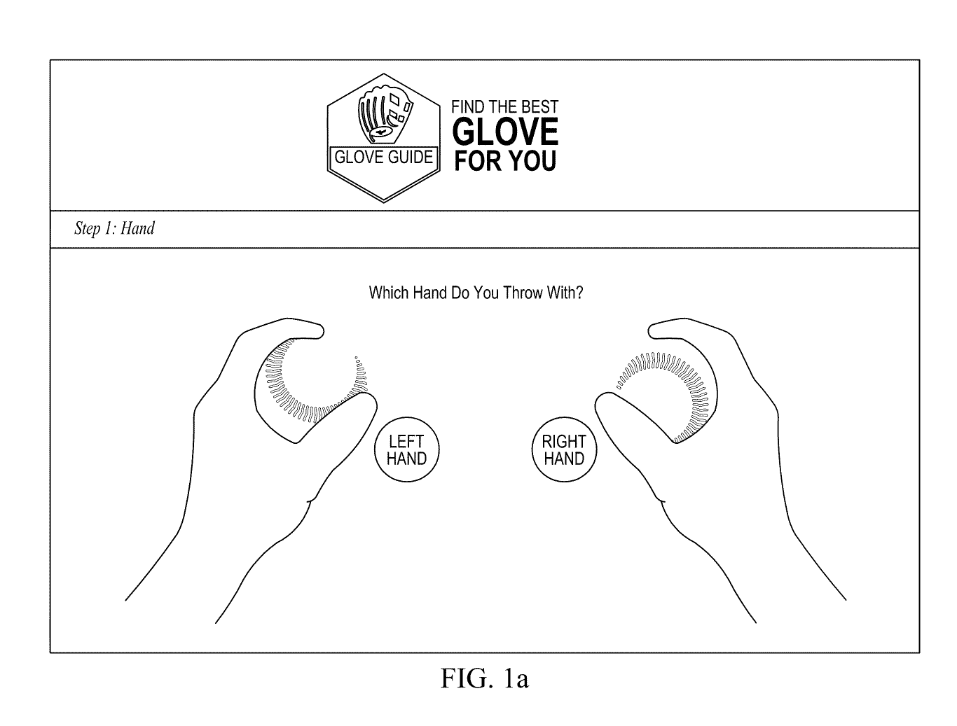

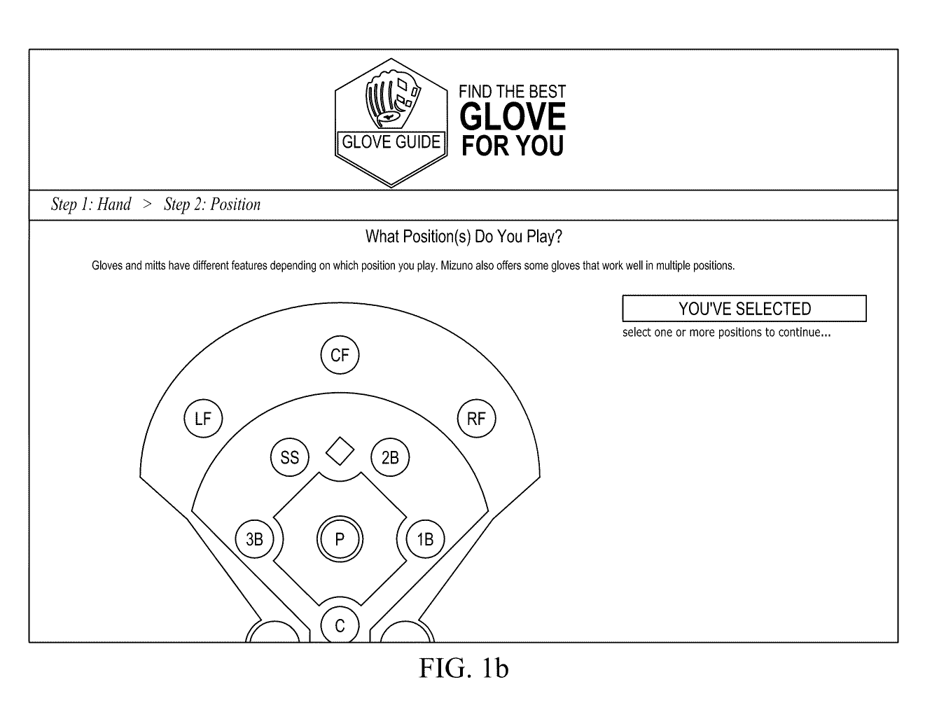

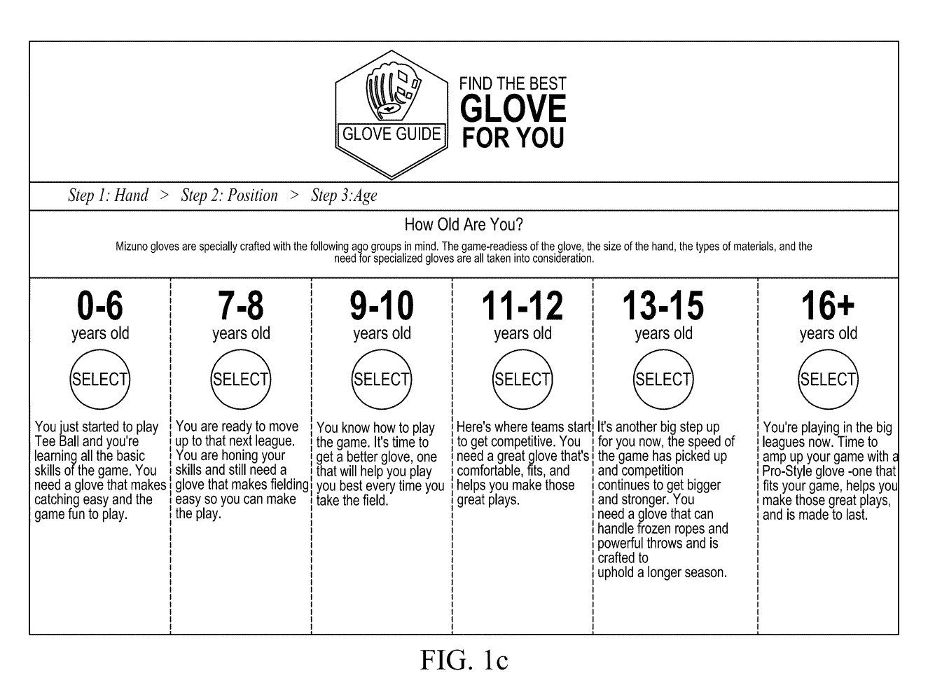

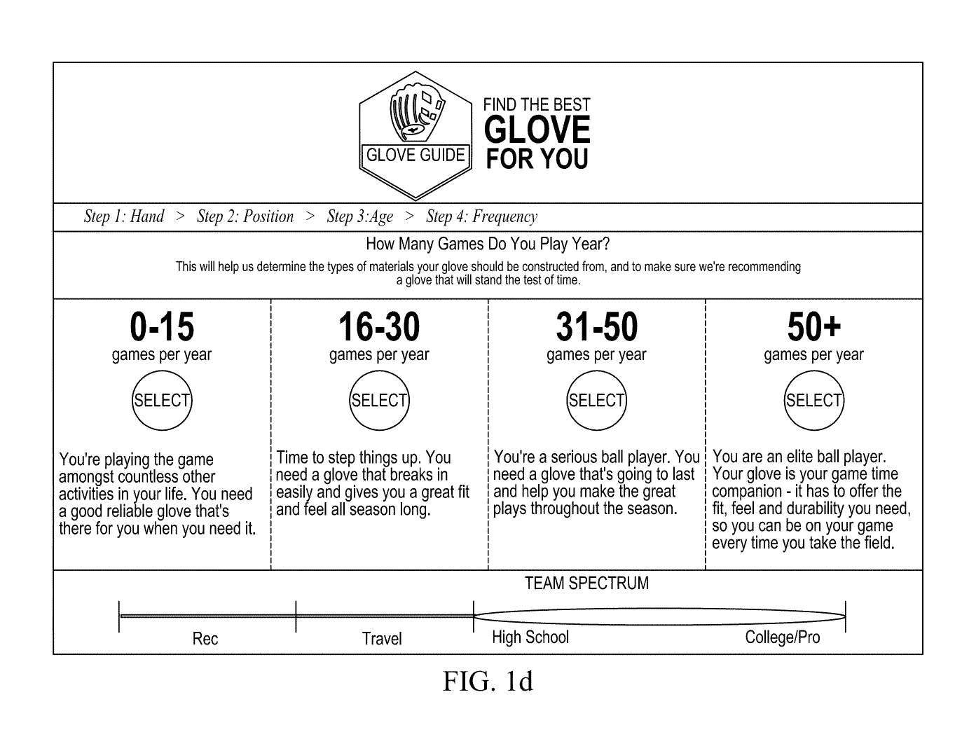

In some embodiments, as shown in FIGS. 1a-1d, the system can comprise a computer or internet based system to enable users to work through a series of menus. The system can then make one or more glove recommendations based on the user's answers. In some embodiments, the questions can include, for example and not limitation, which hand the user catches with, the position they play, their age, frequency of play, and the type of team they play on.

In some embodiments, the system can also include a database of relevant glove specifications that coincide with the questions asked of the user. The system can then perform a look-up based on the user's answers to find the glove, or gloves, that most closely match the user's needs.

### EXAMPLE

In some embodiments, the system can assign numerical values to the answers provided by the user in order to match the user's answer to the most appropriate glove product available. As shown in Table 1, the lookup table can include, for example, the age of the user, the type of team they play on, and the number of times they play in a given time and can assign a value for each answer. These values can then be used in an algorithm to provide an appropriate recommendation.

TABLE 1
User Lookup Table

| | Range | Value |
|---|---|---|
| Age | 5-8 | 1 |
| | 9-12 | 2 |
| | 13-up | 3 |
| Type of Team | Casual | 1 |
| | Organized | 2 |
| | Semi-Pro/Pro | 3 |
| Frequency of Play | Once a month | 1 |
| | Once a week | 2 |
| | Multiple times per week | 3 |

Similarly, as shown in Table 2, in some embodiments, the system can also assign similar values to gloves based on the same criteria. So, for example, larger, more expensive gloves can be recommended to semi pro or pro players (or simply players for whom money is not an important factor), while smaller, less expensive gloves can be recommended for younger players who just play in the neighborhood or play stick ball.

TABLE 2
Glove Lookup Table

| | Age | | Frequency |
|---|---|---|---|
| Glove | Range | Type of Team | of Play |
| Mizuno Youth Prospect Power | 1 | 1 | 1 |
| Mizuno 11.5″ MVP Prime Adult | 3 | 2 | 2 |
| Mizuno 12.75″ Pro | 3 | 3 | 3 |
| Limited Edition | | | |

Of course, other factors could easily be included, and are contemplate herein. The system could also include a price range, position, or other factors to further narrow the search. In many cases, the choice could also include color or materials, brand preferences, or other factors.

In still other embodiments, the system can also include a tag or labeling system to assist shoppers at the point of sale. This could include a color coded system, for example, to provide relevant information about the system. As shown, the system could use color coding to label, for example and not limitation, the age range and type of team the glove is most suited for. In some embodiments, the system can assign a color to a specific age range.

In some embodiments, the system can assign one or more colors to the type of team the player plays on. This could be a simple system with one set of colors such as, for example, beginner, intermediate, and advanced. In other embodiments, the system can include a more specific set of factors such as, for example and not limitation, youth, recreational, or travel combined with high school, college, and or semi-pro/pro levels.

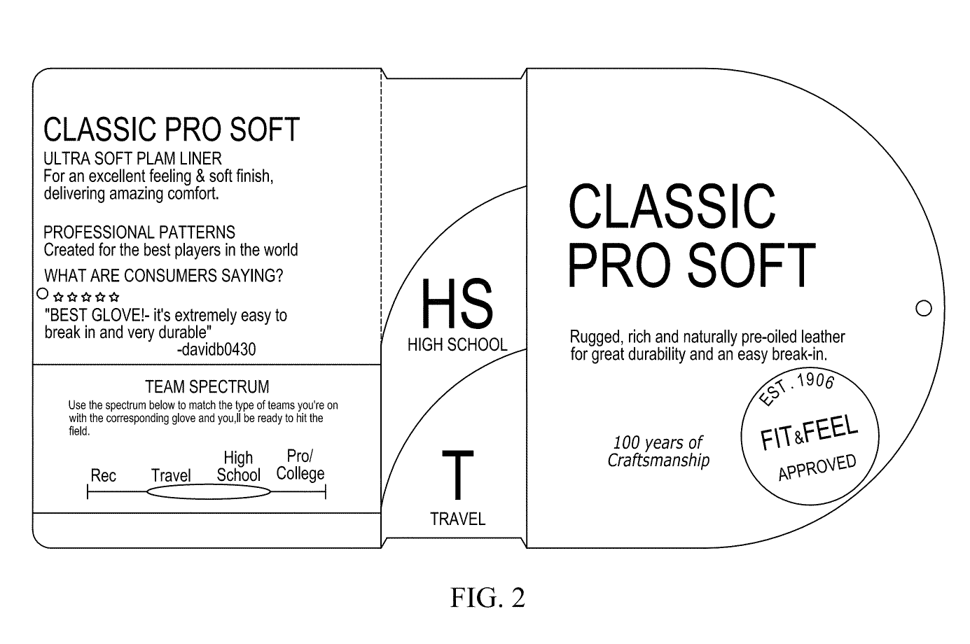

As shown in FIG. 2, the system can also comprise a hang tag, or other suitable label, to provide the information specific to a particular glove. In this manner, gloves with like specifications can be grouped together and clearly labeled for easier selection. The system can enable users to easily select an appropriate glove without help from retailers. This provides users with greater satisfaction and confidence and reduces the number of employees required by retailers, reducing costs.

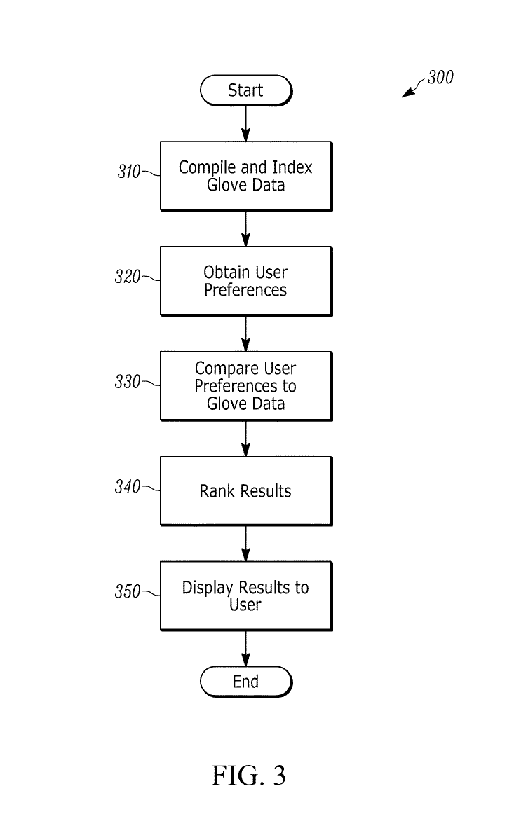

As shown in FIG. 3, embodiments of the present invention can also include a method 300 for selecting a ball glove. Step 310 of method 300 can comprise, for example, indexing a plurality of gloves based on one or more specifications. As discussed above, categories can include, for example, the player's age group, type of play, and frequency of play. Step 320 of method 300 can further comprise retrieving relevant information from the player regarding the specifications. Step 330 of method 300 can further comprise equating the player's answers with one or more gloves. In some embodiments, step 340 can involve ranking the gloves, for example, based on how close each glove is to the player's needs (i.e., a perfect match would be listed first, with less relevant gloves being listed lower). At step 350, method 300 can then present the player with one or more choices, which can be presented in order of relevance, cost, or by brand, for example.

Embodiments of the present invention can also comprise a website for providing the system on an internet, intranet, or other suitable connection. The system can be embodied, for example, in a graphical user interface and can be menu driven or otherwise configured to store the necessary information relevant to each glove, retrieve relevant information from the user, and to provide recommendations to the user as an output. As shown in FIGS. 1a-1d, the system can use simple radio buttons, or other means, to present questions to the user and then provide glove recommendations.

In still other embodiments, the system could be embodied in a kiosk or tablet, for example, at a retail location. The kiosk or tablet could include a touch screen, or other input means, and enable users to enter their information. The kiosk can then process the user's responses and provide one or more recommendations to the user. In some embodiments, the kiosk may be able to provide the location of the recommended glove(s) to expedite the user's shopping experience.

Regardless of the form it takes, the system can improve the user's experience by ensuring the user purchases a glove suited to their needs. The system can also improve the user's experience by increasing the confidence the user has in their choice and decreasing the amount of time required to make the correct choice. The system can also be a driver of sales, as users may prefer to purchase gloves with the system over those without it (where they are reduced to guessing which glove is appropriate). In addition, the system can drive the sale of more expensive gloves as users strive to upgrade, for example, to “Pro-Level” equipment, either because the equipment is better, or just for bragging rights.

Embodiments of the present invention can also comprise a system for organizing and labeling products in a retail or online setting. In some embodiments, the system can enable the shelves in a retail store, for example, to be organized and marked according to the criteria discussed above (i.e., type of team, frequency, etc.). The gloves and shelves can include tags or labels to enable customers to easily locate the proper glove for their needs. The retail outlet can also include signage in various parts of the store to direct customers to areas that have been organized and marked.

In some embodiments, the tags or labels can use, for example, color coding, letter coding, and/or shapes to enable customers to quickly locate the appropriate merchandise. In some embodiments, the system can also be incorporated into a digital design for use on a website. In this manner, the user can select the proper glove prior to going to the store. In some embodiments, the system can also interface with local retailers to enable the user to verify the glove they have selected is in stock. The website can be accessible via an internet connected device such as, for example, a tablet, PC, mobile phone, or laptop.

In some embodiments, the system can also include other baseball equipment (e.g., bats, balls, and cleats), other sporting goods and merchandise, and/or merchandise from multiple manufacturers. The system can be customizable for different types of merchandise to ask appropriate questions for each type of merchandise. So, for example, for athletic shoes, the system can ask, for example and not limitation, what type of activity (e.g., soccer, baseball, running, etc.), the user's age, frequency, skill level, and running distance.

In some embodiments, the system can also incorporate a call center with live or automated help. The system can also collect data to track customer likes and dislikes to be used for customer relationship management (CRM) and inventory control. The system can also incorporate point-of-sale (POS) integration to provide feedback as to whether components purchased together are compatible. In other words, the system can verify that the customer has picked a bat and a glove from the same categories, for example.

While several possible embodiments are disclosed above, embodiments of the present invention are not so limited. For instance, while several possible parameters have been provided for glove selection have been disclosed, more, less, or different parameters could be selected without departing from the spirit of embodiments of the invention. In addition, the location and configuration used for various features of embodiments of the present invention can be varied according to a particular retail location that requires a slight variation due to, for example, the space or power constraints. Such changes are intended to be embraced within the scope of the invention.

The specific configurations, choice of materials, and the size and shape of various elements can be varied according to particular design specifications or constraints requiring a device, system, or method constructed according to the principles of the invention. Such changes are intended to be embraced within the scope of the invention. The presently disclosed embodiments, therefore, are considered in all respects to be illustrative and not restrictive. The scope of the invention is indicated by the appended claims, rather than the foregoing description, and all changes that come within the meaning and range of equivalents thereof are intended to be embraced therein.

What is claimed is:

1. A system for selecting an appropriate ball glove for a user, the system comprising:
a database including one or more parameters corresponding to one or more ball glove products;
a user interface configured to collect information corresponding to the user's playing requirements;
a processor that compares the information collected by the user interface with the one or more parameters of the database; and
wherein the user interface is configured to display, in an order determined by the processor, one or more ball glove products to the user.

2. The system of claim 1, wherein the one or more parameters includes one or more of handedness, age, position, frequency of play, and price.

3. The system of claim 1, wherein the order in which the ball glove products are displayed is in descending order of appropriateness for the user's playing requirements.

4. The system of claim 1, wherein the user interface collects information by prompting the user with one of more questions.

5. The system of claim 1, wherein the system is accessible via an internet connected device.

6. The system of claim 5, wherein the internet connected device includes one or more of a tablet, PC, mobile phone, or laptop.

7. A method for selecting an appropriate ball glove, the method comprising:
providing a user interface configured to collect information corresponding to a user's playing requirements;
inputting information corresponding to the user's playing requirements;
comparing, by a processor, the information corresponding to a user's playing requirements with a database including one or more parameters corresponding to one or more ball glove products; and
displaying, by the user interface, an ordered list of one or more ball glove products.

8. The method of claim 7, wherein the one or more parameters includes one or more of handedness, age, position, frequency of play, and price.

9. The method of claim 7, wherein the ordered list is in descending order of appropriateness for the user's playing requirements.

10. The method of claim 7, wherein the information is inputted in response to prompting by the user interface.

11. The method of claim 7, wherein the user interface is accessible via an internet connected device.

12. The method of claim 11, wherein the internet connected device includes one or more of a tablet, PC, mobile phone, or laptop.

13. A non-transitory computer-readable storage medium containing program code that enables selecting an appropriate ball glove, the medium comprising:
program code for providing a user interface configured to collect information corresponding to a user's playing requirements;
program code for receiving information corresponding to the user's playing requirements;
program code for comparing the information corresponding to a user's playing requirements with a database including one or more parameters corresponding to one or more ball glove products; and
program code for displaying, by the user interface, an ordered list of one or more ball glove products.

14. The medium of claim 13, wherein the one or more parameters includes one or more of handedness, position, age, frequency of play, type of team, and price.

15. The medium of claim 13, wherein the ordered list is in descending order of appropriateness for the user's playing requirements.

16. The medium of claim 13, wherein the information is inputted in response to prompting by the user interface.

17. The medium of claim 13, wherein the user interface is accessible via an internet connected device.

18. The medium of claim 13, wherein the internet connected device includes one or more of a tablet, PC, mobile phone, or laptop.
